(19) United States
(12) Patent Application Publication
(10) Pub. No.: US 2002/0048461 A1
(43) Pub. Date: Apr. 25, 2002

(54) Camera

(75) Inventor: Yasuhiko Tanaka, Saitama (JP)

Correspondence Address: YOUNG & THOMPSON, 745 SOUTH 23RD STREET 2ND FLOOR, ARLINGTON, VA, 22202

(73) Assignee: Fuji Photo Optical Co., Ltd.

(21) Appl. No.: 09/982,951

(22) Filed: Oct. 22, 2001

(30) Foreign Application Priority Data
Oct. 20, 2000 (JP) 2000-320825

(51) Int. Cl. G03B 17/02

(52) U.S. Cl. 396/539

(57) ABSTRACT

A camera body consists of a main body, a front cover, and a rear cover. A cylindrical battery chamber with its back open is mounted on the main body. A battery for supplying electricity to each electric circuit is loaded into the battery chamber. Inside of the battery chamber has a negative contact member and a positive contact member. The negative contact member has an arm, which brings in contact with the inner wall of the front cover electrically. The front cover has conductivity and functions as a ground. As the negative pole of the battery is connected to the front cover of large volume, the electric circuit is not affected by electrostatic noise, to cause malfunction.

### BACKGROUND OF THE INVENTION

1. Field of the Invention

The present invention relates to a camera, more particularly relates to a camera whose electric circuit is not affected by electrostatic noise.

2. Explanation of the Prior Arts

Most of the cameras that have been put on the market are provided with an automatic focusing device, an motor driven zoom device, an automatic wind device and so forth, which are controlled by respective electric circuits. Each electric circuit often generates electrostatic noise by electrostatic induction from outside of the camera. When the electrostatic noise occurs, the device malfunctions or, possibly, becomes incontrollable. To prevent the effect of the electrostatic noise, a negative pole of a battery or an earth line of an electric circuit for driving the electric circuit are connected to a conductive and large-volume member.

According to the camera as mentioned in Japanese Patent Laid-open Publication No.11-174550, for instance, a cover covering a main body with a taking mechanism is made from conductive aluminum. A flexible board on which the electric circuit is mounted is screwed on the cover so as to contact with a conductive pattern of the flexible board. The conductive pattern is connected with the earth line of the electric circuit.

The flexible board is disposed close to the aluminum cover in the camera. Therefore, by screwing them down, it is electrically possible to contact the earth line of the electric circuit with the cover.

In case the electric circuit is formed on the hard circuit board such as an epoxy plastic, however, it is difficult to connect the circuit board with the cover electrically. Although it is possible to attach the flexible board for connecting with the circuit board, the flexible board is expensive, which causes a cost increase in camera.

### SUMMARY OF THE INVENTION

An object of the present invention is to provide a camera that can connect a negative pole of a battery to a cover having a ground function.

Another object of the present invention is to provide a camera that has simple structure and can prevent from generating an electrostatic noise in an electric circuit.

To attain the above objects and the other object, a battery contact member which contacts with the negative pole of the battery forms an arm for touching with the inner wall of a cover. The cover has conductivity and covers at least a part of a main body incorporating a taking mechanism. The battery contact member is made of a metal sheet and the arm contacts with the cover by its elasticity.

The top of the main body has a battery chamber, to which the battery contact member is secured. The arm of the battery contact member that extends towards the cover in slanting state. The tip part of the arm is bended to form a contact part. As the tip of the arm is lowered down so as to keep away from the cover, it is unlikely to strike the edge of the cover while attaching the cover. When the contact part is pushed by the cover member, the arm is elastically deformed. Consequently an appropriate contact pressure is applied to contact the contact part with the cover member.

### BRIEF DESCRIPTION OF THE DRAWINGS

The above and other objects, and advantages of the present invention will become apparent from the following detailed description of the preferred embodiments when read in association with the accompanying drawings, which are given by way of illustration only and thus are not limiting the present invention:

FIG. 1 is an exterior perspective view illustrating a camera of the present invention;

FIG. 2 is an exploded perspective view of a camera illustrated by FIG. 1;

FIG. 3 is an exploded view of structure of a battery chamber;

FIG. 4 is a vertical sectional view of an essential part of camera of the present invention; and

FIG. 5 is a transverse sectional view of an essential part of camera of the present invention.

### DETAILED DESCRIPTION OF THE PREFERRED EMBODIMENTS

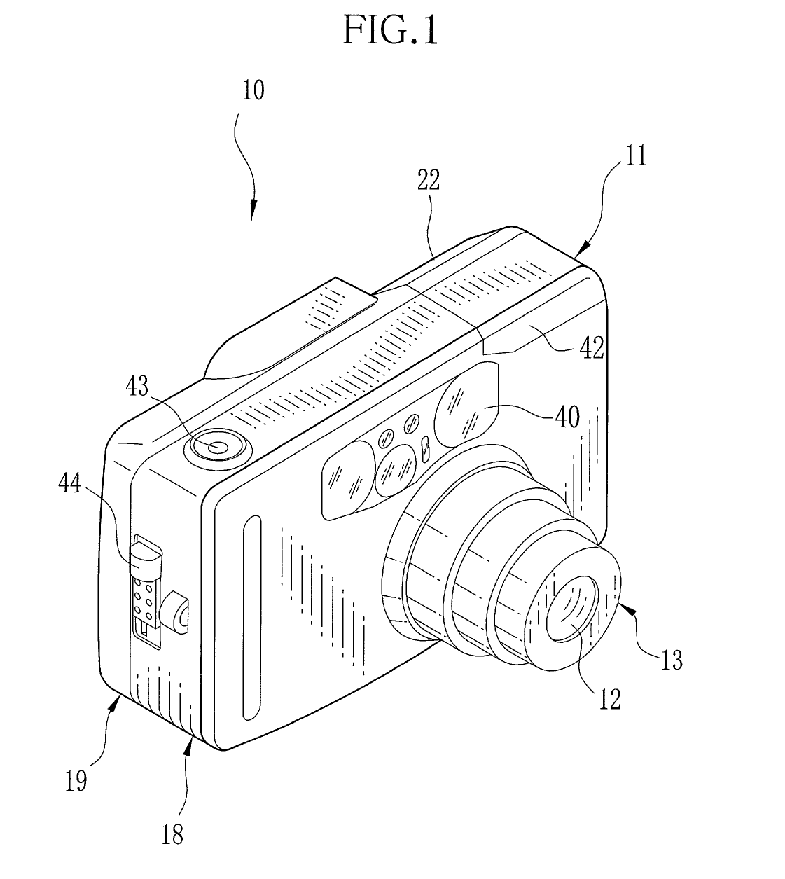

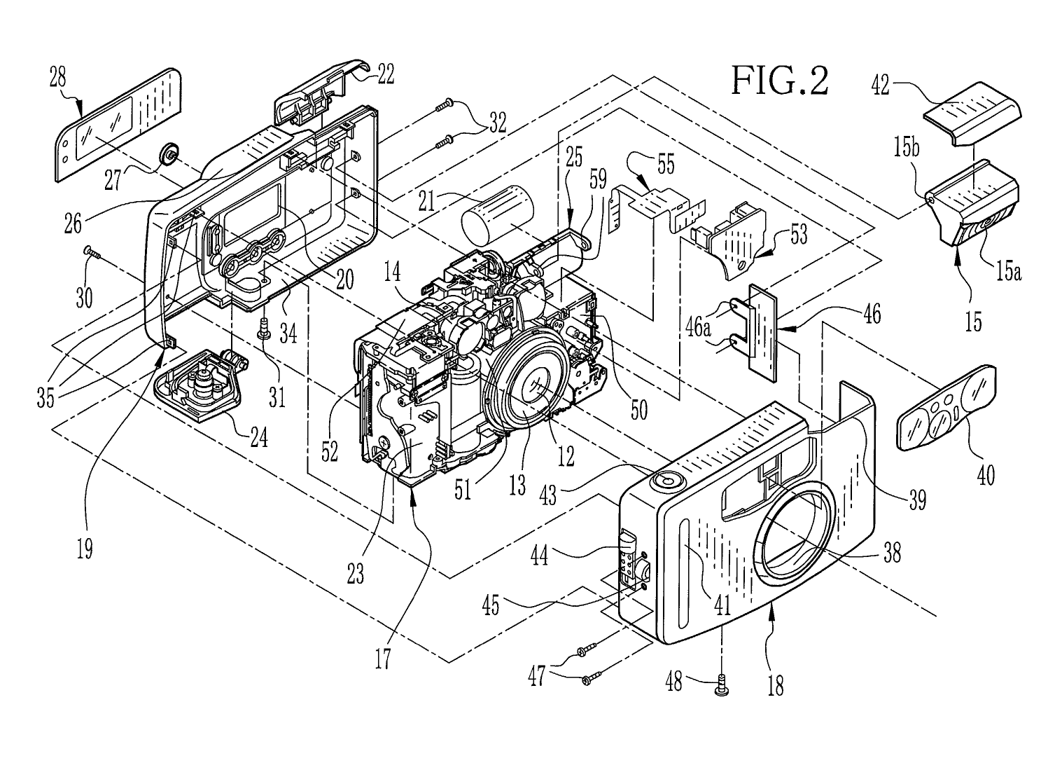

In FIGS. 1 and 2, a camera 10 consists of a camera body 11, and a zoom lens device 13 having a taking lens 12. The camera body 11 is constituted of a main body 17, and a front cover 18 and a rear cover 19 that are mounted on the main body 17. The rear cover 19 is made from plastics in consideration of lightweight. And the front cover 18, which uses lightweight and conductive material such as aluminum alloy, is shaped by pressing.

The main body is attached to the taking mechanism, such as a finder unit 14, a flash projector 15, a shutter mechanism, a film advance mechanism and so forth. The finder unit 14 consists of a finder optical system and a distance measuring optical system. The zoom lens device 13 is supported by the main body 17.

There are an opening 20 for exposing a liquid crystal panel and other openings for exposing a finder eyepiece lens, a power switch, a zoom switch and so forth on the rear cover 19. A battery chamber lid 22 is attached swingably to the top of the rear cover 19 and a loading lid 24 for a film cartridge chamber 23 is attached to the bottom of the rear cover 19. A battery chamber 25 for storing a battery 21 is attached to the upper right part of the main body 17.

A bulge 26 for containing the finder unit 14 is formed at the top center part of the rear cover 19. A window for exposing the finder eyepiece lens and an operation member 27 for switching a finder view frame are mounted on the rear of the rear cover 19. A numeral 28 is a protective cover made from transparent plastics for protecting the liquid crystal panel and is attached to the rear cover 19 by an adhesive. Of the rear cover 19, three points of the rear, the bottom, and the right are respectively fixed to the main body 17 by screw 30 and 31, and a coupling screw 32. The inside of the rear and the bottom is touched to fix with the outside of the main body 17.

The rear cover 19 has an opening portion 34 for storing the main body 17. A periphery of the opening portion 34 have engaging projections 35 having a hole. Since pins (not shown) fixing on the front cover 18 insert through holes of the engaging projection 35, the front cover 18 is connected with the rear cover 19. The front of the front cover 18 has an opening portion 38 through which the zoom lens device 13 moves forth and backward, and a cutout portion 39 for placing a diffusion plate 15a of the flash projector 15. Also a finder cover 40 and a grip projection 41 are fixed on the front cover 18. The grip projection 41 is arranged so that fingertips would be securely put on holding the left part of the camera body 11 with right hand. In addition to that, though the grip projection 41 is made by plastic-forming, it is preferred to be plated with metal in order to have a unified feeling with the front cover 18.

The cutout portion 39 is cut out in succession from the front to the top in accordance with the shape of the flash projector 15. A flash cover 42 is attached to the top of the flash projector 15. When the flash projector 15 is in a storage position, the top of the flash projector 15 is covered by the flash cover 42. The flash cover 42 is, like the front cover 19, formed by press-forming of aluminum alloy.

The finder cover 40 is made from transparent plastics and covers the finder unit 14. The light-shielding film is partly put on the finder cover 40 from backward. As a result, the parts which are not relative to the finder object lens and an optical system for measuring distance are light-shielded, making the inside of the camera body 11 invisible.

The top of the front cover 18 has a shutter button 43. The left side of the front cover 18 includes a loading lid lever 44 for operation upon opening and closing the loading lid 24, and a strap holder 45 for attaching a strap. And the other side of the right side has a connecting portion 46 that connects with the rear cover 19 and the main body 17. When the loading lid lever 44 is slid down, the loading lid 25 is opened. In case a photographic film is pulled from the film cartridge in the cartridge chamber 23, the loading lid lever 44 is locked to prevent the loading lid 24 from opening.

The connecting portion 46 has an insertion hole 46a, through which the connecting portion 46 is connected with the rear cover 19 and the right side of the main body 17 by the coupling screw 32. Further, other insertion holes for inserting screws are formed in the left side and the bottom of the front cover 18, which are directly touched with the main body 17, to be screwed down by respective screws 47 and 48.

On the main body 17 attaches the cartridge chamber 23, a film winding chamber 50 for winding the photographic film from the film cartridge, and a fixed barrel 51 for holding the movable lens barrel of the zoom lens device 13. The cartridge chamber 23 and the film winding chamber 50 are disposed so as to sandwich the fixed barrel 51. Behind the fixed barrel 51 is positioned an aperture that prescribes the range of exposure to the photographic film.

A drive axis for rotating a spool of the film cartridge and a mechanism for opening and closing the cartridge shutter and so forth are attached to the upper part of the cartridge chamber 23. A main flexible board 52 on which a CPU (not shown) for controlling each part of the camera body 11 and so forth are mounted on the cartridge chamber.

A flash circuit board 53 is attached to the front of the film winding chamber 50. And the flash projector 15 and the battery chamber 25 are attached to the upper part of the film winding chamber 50. Several kinds of electric elements such as transformer coil are attached to the flash circuit board 53 having a circuit pattern. The flash circuit board 53 is connected to the flash projector 15, the main flexible board 52, and battery contact members 57 and 58 through the flexible circuit board 55. The flash circuit formed on the flash circuit board 53 is controlled by the CPU on the main flexible board 52, to flash the flash projector 15.

The flash projector 15 has a flash discharge tube and a reflector inside of the diffusion plate 15a combining a protector. The flash projector 15 is attached to a bracket 59 through an axle 15b and rotates between an exposed position for exposing the diffusion plate 15a outside and a storing position for storing the diffusion plate 15a into the camera body 11. The battery chamber 25 is mounted at the rear of the flash projector 15.

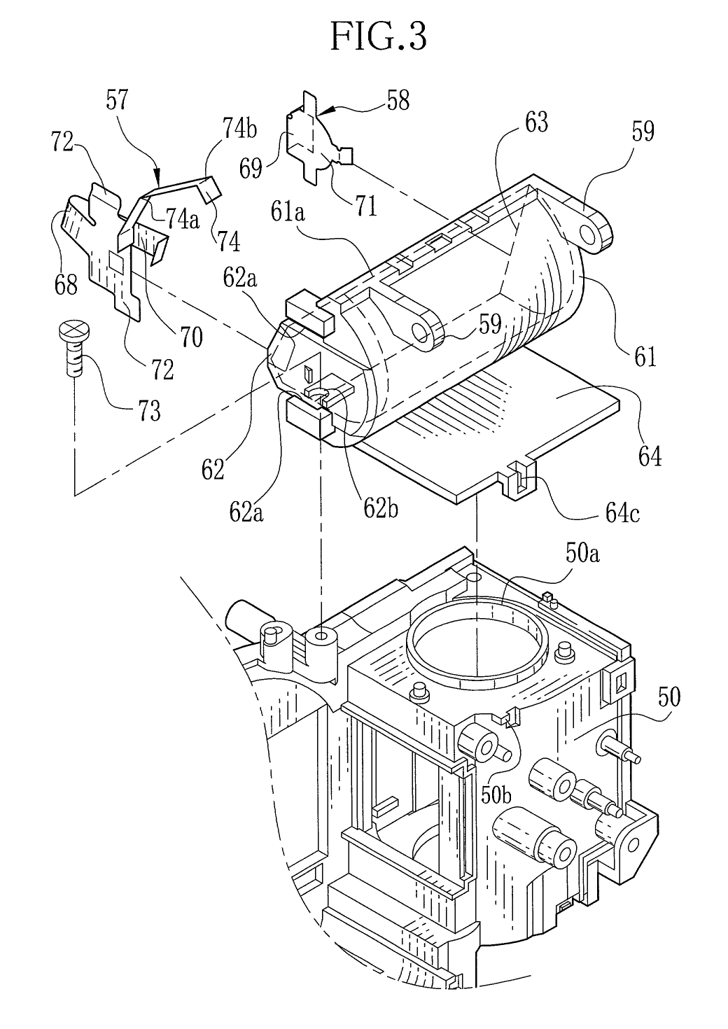

As shown in FIG. 3 in detail, the battery chamber 25 consists of a storage portion 61 for storing the battery 21, mounting parts 62 and 63, and a plate portion 64 to cover the top of the film winding chamber 50 light-tightly. The storage portion 61 is roughly in the form of a cylinder with backward open. The battery 21 is loaded from a loading opening 61a. And the front side of the storage portion 61 has the brackets 59 for attaching the flash projector 15.

Both sides of the storage portion 61 have the mounting parts 62 and 63 to which the negative contact member 57 and the positive contact member 58 are attached, which are respectively connected with the negative pole 21a and the positive pole 21b of the battery 21.

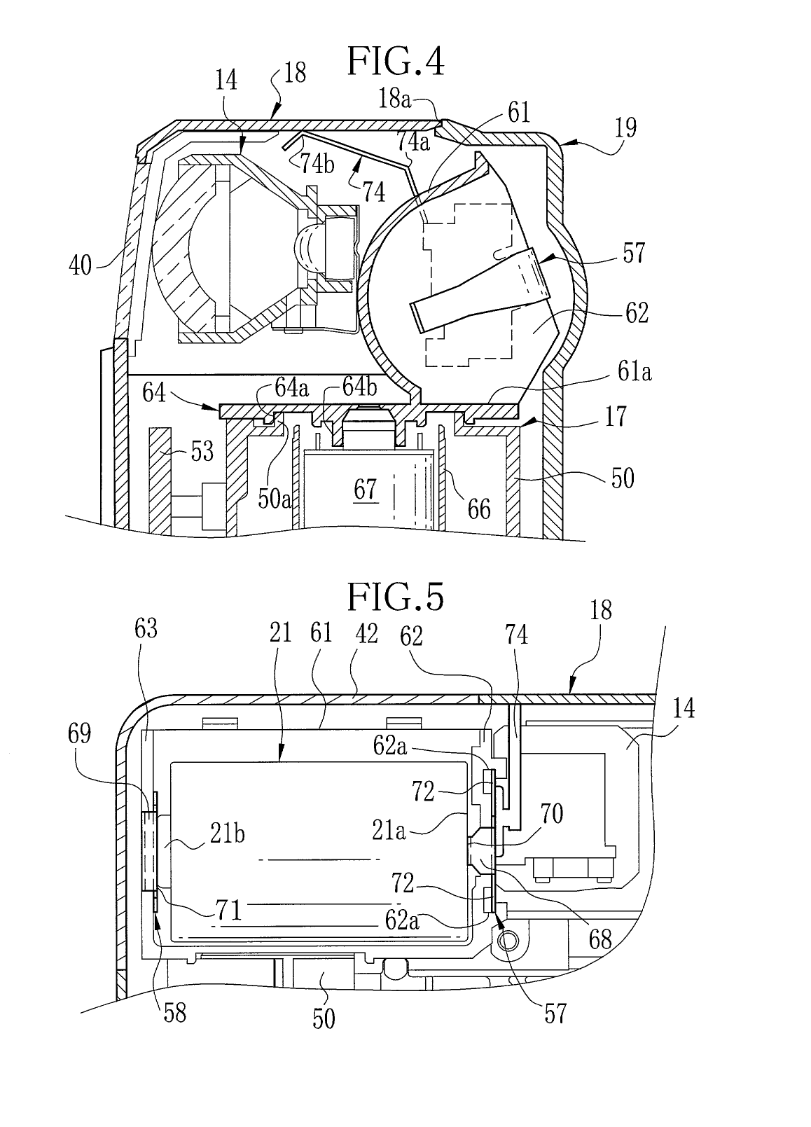

As shown in FIG. 4, the plate portion 64 is a roughly rectangular-shape that matches with the top of the film winding chamber 50. A column-shaped concave portion 64a fits the outside of the cylinder-shaped convex portion 50a formed on the film winding chamber 50, to cover the film winding chamber 50 light-tightly. There forms an engaging portion 64b that supports a motor 67 for a film winding at the center of the concave portion 64a. The front of the plate portion 64 includes an arresting hole 64c, which is locked by a hook 50b of the film winding chamber 50.

By stamping out and bending a metal sheet, the negative contact member 57 and the positive contact member 58 are formed shown by FIGS. 3 or 5. Each contact member 57 and 58 has clamp portions 68 and 69, which are bent so as to clamp the mounting parts 62 and 63. Of one end of the clamp portions 68 and 69, the part that is bent into the inner wall side of the battery chamber 25 becomes a negative contact 70 and a positive contact 71, which respectively come in contact with the negative pole 21a and the positive pole 21b of the battery 21 loaded into the storage portion 61.

The mounting part 62 has a slit 62a that is made in accordance with a thickness of the negative contact member 57. Fitting quadrilateral inserting portions 72 at an upper and a lower of the negative contact member 57 to the slit 62a positions the negative contact member 57 and strengthens a connection between the mounting part 62 and the negative contact member 57. The mounting part 62 has a cutout 62b into which a connection screw 73 is inserted. The battery chamber 25 is connected to the main body 17 by locking the hook 50b into the arresting hole 64c and screwing down with the connection screw 73.

The upper end of the negative contact member 57 has a ground arm portion 74 for connecting the negative pole 21a of the battery 21 with the front cover electrically. The ground arm portion 74 is positioned outside of the battery chamber 25, protruding towards the inner wall of the front cover 18 situated in the upper part of the battery chamber 25.

The ground arm portion 74 is bent obliquely at a first bending part 74a and further bent at a second bending part 74b. The first bending part 74a is for touching the ground arm portion 74 in oblique state with the inner wall of the front cover 18. The tip of the ground arm portion 74 is lowered down unless the second bending part 74b conflict with the edge of the front cover 18 upon assembling. The angle of the first bending part 74a is determined so that the ground arm portion 74 comes under an appropriate pressure to contact with the inner wall of the front cover 18.

The effect of the above embodiment will be explained. In the assembly process of the camera 10, there attaches the taking mechanism such as the zoom lens device 13 and the finder unit 14 to the main body 17. Further, there attaches the battery chamber 25 having the battery contact members 57 and 58 attached thereon, the flash projector 15, the flexible board and so forth to the main body 17. The front cover 18 includes the finder cover 40, the grip projection 41, the loading lid switch 44 and so forth. And the rear cover 19 attaches the protective cover 28 and several kinds of switches thereto.

While letting the zoom lens device 13 in the opening portion 38, the main body 17 is covered by the front cover 18 from forward and is covered by the rear cover 19 from rearward. Then the front cover 18 and the rear cover 19 are fastened to the main body by screws.

As mentioned above, the first bending part 74a extends the ground arm portion 74 of the negative contact member 57 towards the oblique front, therefore it is parallel to the attachment direction of the front cover 18. On attaching the front cover 18, the oblique part, which is ahead of the second bending part 74b of the ground arm portion 74, contacts with the joint side 18a of the front cover 18. Further covering the front cover 18 towards the rearward of the main body 17, the second bending part 74b enters downward of the joint side 18a. The ground arm portion 74 makes a smooth approach to the inside of the front cover 18 along the attachment direction of the front cover 18 while the second bending part 74b contacts with the inner wall of the front cover 18.

After the front cover 18 is entirely set in the main body 17, the ground arm portion 74, due to the angle of the first bending part 74a, contacts with the inner wall of the front cover 18 at an appropriate pressure. Electrically the negative pole 21a of the battery 21 is connected to the front cover 18 of aluminum alloy through the ground arm portion 74. The front cover 18 functions as a ground, absorbing the electrostatic noise.

According to the above embodiment, the front cover is made from aluminum alloy. However, other metal is also suitable as long as it has conductivity. Moreover, it is also suitable to ground the rear cover or the main body in place of the front cover. Furthermore, it is also suitable to provide a top cover and a bottom cover for covering the top and bottom of the camera body and to make either of which out of conductivity materials at least. Connecting the negative pole of the battery with the front cover is electrically equivalent to connecting the negative line of the electric circuit with the front cover.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1 A camera having a main body with a battery chamber which is loaded a battery for driving a taking mechanism, said camera comprising:
a cover for covering a part of said main body at least, said cover having conductivity;
first and second battery contact members provided in said battery chamber, said first and second battery contact members coming in contact with a positive pole and a negative pole of said battery; and
an arm formed in said first battery contact member, said arm being contacted with an inner wall of said cover by its elasticity.

2 A camera as claimed in claim 1, wherein said first battery contact member contacts with said negative pole, while said second battery contact member contacts with said positive pole.

3 A camera as claimed in claim 2, wherein said first battery contact member is made out of thin metal plate.

4 A camera as claimed in claim 3, wherein said arm extends to an attachment direction when said cover is attached to said main body.

5 A camera as claimed in claim 4, wherein said arm includes a first bending part formed on its way, said arm being inclined to said cover by said first bending part.

6 A camera as claimed in claim 5, wherein said arm has a second bending part formed between a tip of said arm and said first bending part, said second bending part being contacted with an inner wall of said cover, said tip of said second bending part being lowered for preventing said tip from conflicting with said inner wall of said front cover.

7 A camera as claimed in claim 6, wherein said battery chamber is mounted on said main body.

8 A camera as claimed in claim 7, wherein said battery chamber is roughly semi-cylindrical with its rear open and both sides closed, said both sides having said first battery contact member and said second battery contact member.
